(19) United States
(12) Patent Application Publication
(10) Pub. No.: US 2007/0193056 A1
(43) Pub. Date: Aug. 23, 2007

(54) Dryer assembly

(76) Inventor: Marius Switalski, Des Plaines, IL (US)

Correspondence Address: SCHWARTZ COOPER CHARTERED;IP DEPARTMENT, 180 NORTH LASALLE STREET, SUITE 2700, CHICAGO, IL, 60601, US

(21) Appl. No.: 11/358,938

(22) Filed: Feb. 21, 2006

(51) Int. Cl. F26B 19/00; A23L 1/00; F26B 3/00

(52) U.S. Cl. 34/88; 426/89; 34/484

(57) ABSTRACT

A textile dryer capable of monitoring heating chamber temperature (internal thermocouple), peak ink temperature (absorption infrared probe at exit), real-time ink temperature (donut thermocouple) as the textile travels through the chamber, and gas consumption is disclosed. A controller permits one to set numerous parameters and view graphs of the monitored variables over time. Recipes or job settings can be stored for recall and use later. In addition, visual and audible warnings and alarms are incorporated into the system.

### CROSS-REFERENCE TO RELATED APPLICATIONS

None.

### TECHNICAL FIELD

The present invention relates generally to an assembly for curing inked textiles and substrates and, more particularly, to a novel dryer containing a plurality of sensors for more aptly monitoring and controlling the temperature of the drying chamber and the inked product traveling therethrough.

### BACKGROUND OF THE INVENTION

Indicia applied permanently to articles of clothing and other textiles have become very popular. Fanciful indicia, such as logos, slogans, college names, sports team names and sayings, are now commonplace. As a result, screen printing textiles is very popular. Large, commercial operations for screen printing textiles are common. Indicia on a textile or substrate (e.g., for transfers), herein referred to collectively as articles, can be one or more colors. Typically, a screen printing machine has at least one station for each color employed. For example, a design incorporating two colors will have at least two printing stations, one for each color. A design employing eight colors will have at least eight stations. Each station generally includes a printing head, which supports a single screen, the ink used at that station and a mechanism for applying the ink to the article. Each color is carried by a single screen. The article to be screened travels from printing station to printing station by one of a number of methods, such as a chain or a rigid arm. The article is usually carried by a metal pallet, pallet support, flat bed, or platen. Common printing machines include turret, oval and linear type machines.

Some printing machines incorporate curing stations therein between printing stations and/or before removing the article from the machine. Frequently, operations employ separate dryers. Some shops will use both systems to ensure the ink is properly set. A dryer has two primary components, a conveyor system and a heating system. At present, the drying of an article with printing thereon is performed by the operator first setting the temperature inside the dryer and then setting the speed of the conveyor system. Commonly known mechanisms may be employed to determine/read the ambient temperature somewhere in the dryer, permitting the operator to adjust the conveyor speed to compensate for temperatures reading too high or too low.

Numerous inks are available in the industry from many different producers. Such inks include water base, sublimation and plastisol. The ink is cured, or gelled, on the article to a critical temperature. The temperature during the curing process must be kept within a window suitable for the ink-curing conditions, typically between 125° F. to 450° F. Unfortunately, with some inks and/or articles, temperatures are crucial. The quality and lifetime of a product may be negatively affected by incorrect temperatures. For example, with plastisols, the temperature must reach 320° F.; the time for this heating can be less relevant. However, in a range (below 320° F. or above 350° F.), the plastisol will not properly set, resulting in cracking or liquefying. For example, if the temperature is too low, the plastisol will not cure properly, and will not adhere to the article; if the temperature exceeds 350° F., the plastisol will over-gel. Similarly, if a dye in the article is overheated, it will migrate. And, the article may scorch or burn, thereby ruining the product and increasing waste and production costs.

As a result, there is a need to both monitor the dryer's temperature in multiple locations, sense the temperature of the textile/substrate and/or ink on the textile/substrate, as opposed to the ambient temperature of the system, and control the same.

In an effort to fulfill these needs and to continuously improve upon the screening/printing process and machines available in the marketplace, the following advancements and improvements were developed to the apparatus and method of drying textiles and substrates once they have been inked and printed upon.

### SUMMARY OF THE INVENTION

The dryer of the present invention is a computer-controlled gas textile dryer. It has high production capacity, with high product throughput and fast cure rates to maximize dryer capacity and minimize per-unit cost. Heavy-duty thermal insulation prevents heat from migrating into the workplace, with further technology leaving the dryer skin cool to the touch.

Specifically, the dryer provides real-time dryer performance data, including dryer temperature, gas consumption, and the temperature of substrates as they travel through the heat chamber and as they exit the chamber. This information allows the operator to achieve exceptional curing accuracy and consistency. It can be used to program up to thirty (30) jobs into the system for recall at a later time. In particular, individually stored settings can be recalled later for any job with similar substrate and ink combinations. Swiveling control panels are rail-mounted to the dryer's exterior, allowing them be moved to the front or rear of the dryer. Each dryer's LCD touch-screen monitor displays key operational information—like heat chamber temperature, belt speed, and outfeed (ink) temperature and gives operators complete control of parameters, alarms, and service data. A tower light further shows when temperatures are within user-set parameters. When temperatures fall outside those settings, the dryer issues visible and audible alarms to alert the operator.

The dryer can use liquid propane (LP) or natural gas (NG). The high-performance burners are designed with excess capacity far exceeding consumption rates under normal operating conditions. Separate blowers control combustion, circulation, and exhaust. A high-volume forced air system quickly brings the chamber up to the desired temperature, speeding the start of production. In particular, the dryer combines a high performance burner with three dedicated blowers to deliver temperature consistency and exceptional curing rates. The circulation blower forces heated air through the vector knife air plenum and across the belt, the power blower provides independent combustion air for the direct-fired burner, and the exhaust blower evacuates up to 1800 scfm. The resulting flame promotes fast, even, and efficient curing. As such, the insulated chamber holds uniform temperatures throughout the chamber and across the belt passing therethrough with the textiles being dried or cured.

A double-wall construction and heavy-duty industrial insulation layer increases dryer efficiency, while simultaneously reducing outer skin temperature.

Process temperatures and set temperatures are controlled digitally. Temperature consistency is ensured by a fuzzy-logic controller, which responds to ambient temperature changes by keeping chamber heat within 10 of target temperature at the thermocouple within the drying chamber.

The dryer of the present invention can also be constructed in five (5) widths, e.g., single-burner models with five standard heat chamber lengths. Four-foot (122 cm) conveyor extension sections and two-foot (61 cm) expansion heat chamber sections can be added.

### BRIEF DESCRIPTION OF THE DRAWINGS

To understand the present invention, it will now be described by way of example, with reference to the accompanying drawings in which:

FIG. 1 is a side elevation view of the dryer made in accordance with the teachings of the present invention;

FIG. 2 is a schematic front prospective view of the dryer of FIG. 1;

FIG. 3 is a schematic side elevation view of the dryer of FIG. 1 generally showing the placement of certain sensors;

FIG. 4 is a front view of the controller;

FIGS. 5-26 are pictures of the touch screen on the controller at different points;

FIG. 27 is a general view of the thermocouple probe;

FIG. 28 shows a demonstration of placing the thermocouple probe on a textile;

FIG. 29 shows the thermocouple probe on a textile;

FIG. 30 is a sample graph of the ink temperature as monitored by the outfeed temperature probes;

FIG. 31 is a schematic front perspective view of the outfeed sensors;

FIG. 32 is a flow-chart for the controller; and,

Appendix A is a chart showing the input and output of the programmable logic controller for the system.

### DETAILED DESCRIPTION OF THE INVENTION

While this invention is susceptible of embodiment in many different forms, there is shown in the drawings and will herein be described in detail preferred embodiments of the invention with the understanding the present disclosure is to be considered as an exemplification of the principles of the invention and is not intended to limit the broad aspect of the invention to the embodiments illustrated.

Referring generally to the figures, the disclosed dryer assembly is generally referenced by the number 10 in the following disclosure and drawings. Other components are similarly and consistently numbered throughout the specification and drawings.

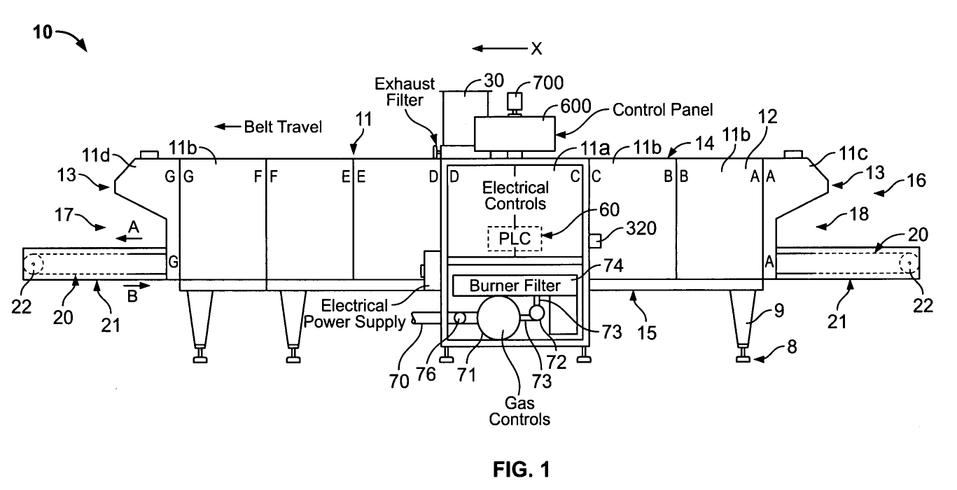

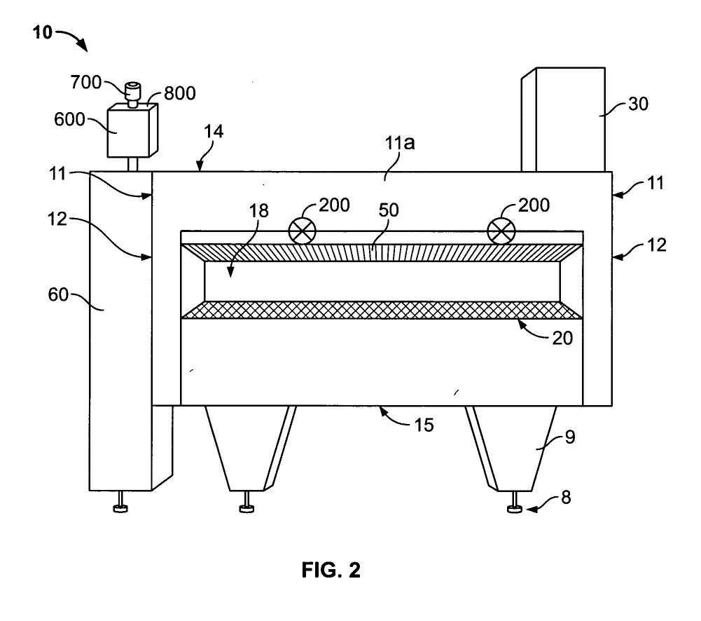

Turning to FIG. 1, a dryer assembly 10 includes a dryer housing 11 wherein the articles passing therethrough (Arrow X) are heated within the heating chamber 18. The housing 11 is formed of opposed side walls 12, opposed end walls 13, a top wall 14 and a bottom wall 15. Such walls and panels are generally constructed of sheet metal with a double wall construction surrounding a layer of insulative material to assist in keeping the outer walls relatively cool to the touch. At one end of the housing 11 there is an entrance opening or infeed end 16 and at the other end there is an exit opening or delivery end 17.

The housing 11 includes a master heat chamber 11a, heat chamber extensions 11b, an infeed exhaust hood 11c, and a delivery exhaust hood 11d. The end walls 13 actually comprise the infeed exhaust hood 11c and the delivery exhaust hood 11d. The heating chamber and housing 11 can be extended by adding heat chamber extensions or heat expansion modules 11b to the infeed and delivery ends of the master chamber 11a. Typical heating chambers are 8 ft-16 ft in length with widths of 38″ (96.5 cm), 48″ (121.9 cm), 60″ (152.4 cm), 72″ (182.8 cm), and 82″ (213.4 cm) and heights of about 53″ (134.6 cm).

Passing through the housing 11 and heating chamber 18 is a conveyor system 20 and an air plenum 50. The conveyor system is preferably a continuous belt 20 supported on a frame 21 (support rails), with the belt having a highly porous (or open mesh) surface area, such as a screen, mounted around (entrained) at least two rollers 22 supported by the frame 21. The preferred belt is a heat-resistant, Teflon® coated fiberglass. The belt 20 is driven by a motor (not shown) in the direction indicated by Arrow A and Arrow B so that items resting thereon, such as textiles, pass through the chamber 18 between the side walls 12 of housing 11 from the entrance opening 16 to the exit opening 17. The continuous belt 20 of the conveyor system should be of sufficient width to carry large or oversized articles such as sweatshirts, nightshirts, and the like. The length of belt 20 is obviously dictated by the size of dryer 10, but this length must be taken into consideration when setting the speed of travel through housing 11. That is, a sufficient residence time within the dryer 10 must be allowed for each printed article. The conveyors 20,21 generally extend beyond the openings 16,17 to points outside the housing.

Generally, the housing 11 and conveyor system 20,21 are supported by rigid legs 9 with adjustable contacts 8 permitting leveling of all the components. While not shown, it is understood that such legs 9 and contacts 8 can be used to support the frame 21 cantilevered from the housing 11 and holding the belt 20 and rollers 22.

The system preferably cures or dries inks through the convection process, a versatile low temperature industrial heating process.

There are generally three blowers employed in the system controlling combustion, circulation and exhaust. Specifically, an air plenum 50 is positioned above or below the belt for directing air, particularly heated air, onto the printed articles resting on the belt 20 passing thereunder. As is well known in the art, a conventional air blower (not shown) having an air outlet (high pressure) side and an air inlet (low pressure) side may be positioned within or adjacent the exterior housing 11. The air ducts (not shown) are connected to the outlet (high pressure) side of the air blower and direct the air from the blower into the drying chamber 18 and onto the surface of the air plenum 50. Air ducts connected to the air inlet (low pressure) side of the air blower recycle the air used to cure the articles. Heating elements (not shown) above the plenum 50 and within the housing 11 may be any conventional type heater known to those skilled in the art, such as electric resistance heaters, infrared heaters, flash lamps, or the like. The input BTU for such burners is between 200,000 BTU and 390,000 BTU. These heating elements heat the incoming air before it reaches the article, but also, generally, heat the drying chamber to a temperature range up to about 450° F. or 230° C.

A return air duct (not shown) located below the conveyor 20 directs the air passing through the housing 11 and conveyor 20 to the air inlet side of the blower to be discharged as exhaust air via a stack 30 or back into the dryer 10, thereby re-circulating the heated air and increasing the assembly's efficiency. Alternatively, the air may be released from the drying chamber 18 via an air duct (not shown) to the surrounding atmosphere.

A control panel 600 with a touch screen 601 is shown adjacent the housing 11. It should be known that the controller or control panel 600 can be supported on or within a track or rail mounted along the oven chamber and made with a swivel connection so as to permit it to rotate. As such, an operator can move the controller to a position (along the length of the unit where it can best be viewed. The controller is accordingly tethered to an electrical umbilical line sitting within a chain contained or held adjacent the track or rail. The chain can thus ride in a space disposed between the oven chamber's outer wall and the track or rail. This track or rail is expandable in the event the oven chamber is extended.

An external gas line 70 connects to a source of gas (not shown) for the system. Generally, the gas line 70 feeds gas into manual shut-off valve 76 to a gas regulator 71 into a feed line 73 and through a filter 74 to the gas burners (not shown). An in-line gas meter 72 is disposed in the feed line 73 between the regulator 71 and the burners.

General Operation of the System

As the printed substrate (e.g., textile, garment, etc.) enters the dryer, it is subjected to heated forced air at a process temperature of about 325° F. to 350° F. for a retention time of about 2.5-3 minutes. After entry into the heat chamber 18, the garment passes under a series of specially designed air knives which uniformly direct forced heated air across the substrate's surface. Exposure to the heated forced air effectively evaporates moisture and solvents in the ink. The resultant by-products are then exhausted from the dryer chamber. Additional advantages are realized in that the conveyor belt speed may be increased, reducing garment shrinkage and bleed through when using opaque inks.

The dryer may be equipped with an optional infrared pre-heat module (not shown) for use in curing/drying plastisol inks. The addition of the infrared pre-heat module gives the dryer two methods of process heating, convection and radiant. This configuration provides a synergistic effect when used in tandem. This synergy offers security for the proper fusion of plastisol ink systems.

The following are typical settings used for the curing/drying of water or solvent based inks used for screen printing textiles: 1. Hot air chamber 350° F.; 2. Optional infra-red heat section 850° F.; 3. Retention time 2.5 to 3 minutes; and, 4. Infra-red panel height 3.5 to 4 inches from the top of the textile.

The operation of the dryer assembly 10 is similar to that of the dryer disclosed in U.S. Pat. No. 5,937,535, issued Aug. 17, 1999, and assigned to M&R Printing Equipment, Inc. of Glen Ellyn, the assignee of the present invention. To the extent the '535 patent disclosure is consistent with the goals of the present invention, it is hereby incorporated by reference.

The Program Logic Control

Electrical controls 60 are housed within a separated electrical housing or closet 60 positioned adjacent a side 12 of the housing 11. Within the electrical housing 60 is a PLC, a programmable logic controller, which is a microprocessor-based industrial control system. This PLC has an associated memory and stores information and communicates with other process control components through data links. The PLC used in the present system is used for monitoring, grabbing, collecting, storing and interpreting the system or environment in and about the machine 10. This data is available in real-time for review, storage for later use, or downloadable for review at a later time.

The specific data monitored includes:
Drying Chamber Temperature
Absorption Temperature of Ink
Actual Temperature of Traveling Substrate and Ink Thereon
Belt Speed
Gas Consumption

In addition, the PLC works with an alarm or alert system when certain pre-selected conditions occur. Thus, the Alert-Alarm system alerts an operator the machine is outside a preferred operating parameter or range, such as temperature, for a specific length of time. This Alert-Alarm system has a three color (lights) code: Green—OK; Orange/Amber—Alert; Red—Alarm. Appendix A shows a chart or table relating to the operation of the PLC.

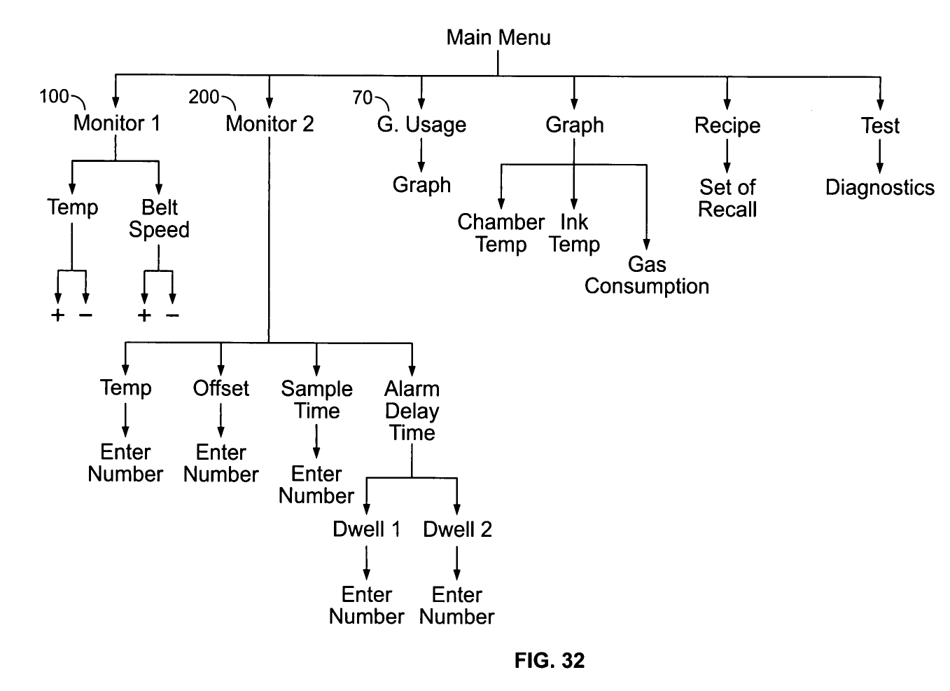

FIG. 32 generally shows a diagram of the screens available to the operator and the settings one can make. For example, the operator can adjust the following parameters: chamber temperature, belt speed and alarm conditions (dwell times, parameters and sample time). These are inputted into the PLC along with the actual temperature readings from the sensors, belt speed and gas meter's reading. The PLC can take this input and compare and adjust the temperature inside the chamber, display the actual readings and settings and control the Alert-Alarm System. The system is also able to display, store and recall for later review the actual operating conditions of the system. The dryer is further able to recall previously set programs to reproduce running conditions for similar textiles.

For example, the information inputted (settings and readings) and outputted by the PLC can also be displayed on a monitor along with a graph showing the settings and readings over time, such as graphs of gas usage over time, Monitor 1 (sensor 100) temperature data over time and/or Monitor 2 (sensor 200) temperature data over time and the settings.

With the use of the traveling sensor, discussed below, one can also generate graph(s) of the temperature profile along the belt in real-time.

The Controls 600

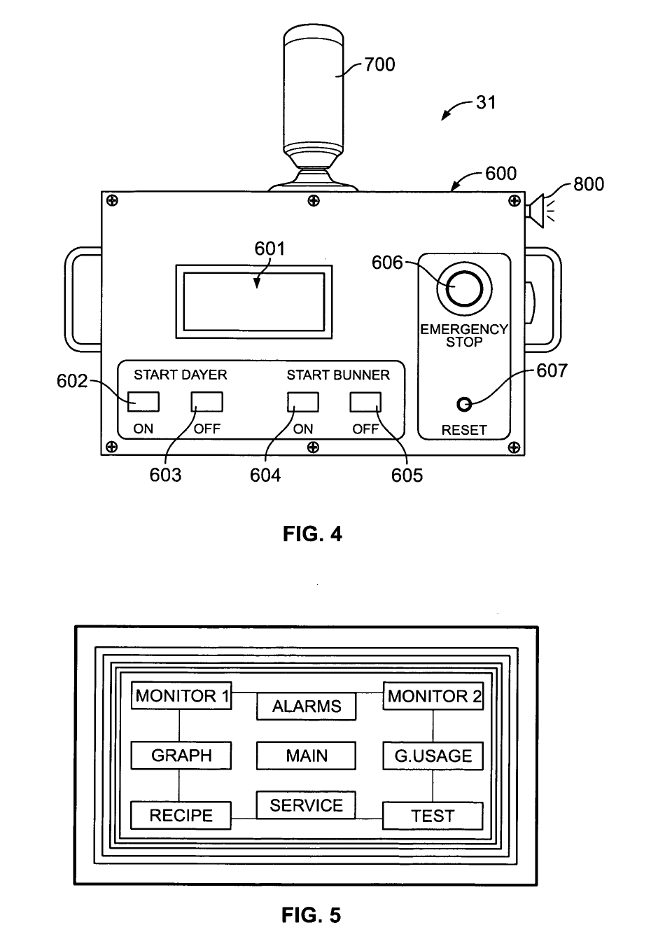

The control panel 600 is shown generally at FIG. 4. It includes the following items:

Start Dryer “ON” (602)—This green lighted push button is used to supply electrical power to the control system. Upon pressing this push button, the push button will illuminate, confirming that electrical power has been supplied to the control system. At the same time, the circulation and exhaust blowers will start and the conveyor belt will activate.

A Start Dryer “OFF” Button (603)—This red lighted push button is used to disconnect (shut down) electrical power to the control system. Upon pressing this push button, it will illuminate, confirming that electrical power has been disconnected. When the temperature inside the heat chamber reaches 150° F., the exhaust blower and the conveyor belt drive will shut down. This allows the inside of the heat chamber to cool down properly, extending conveyor belt life and eliminating the formation of condensation on the interior walls of the heat chamber.

Start Burner “ON” Button (604)—This green lighted push button is used to start the ignition sequence for the gas burner. Upon pressing this push button, the push button will illuminate, confirming that the ignition sequence has begun. At the same time, an automatic “Purge” cycle will begin. This “Purge” cycle will run for approximately two minutes, after which the gas burner will automatically ignite.

Start Burner “OFF” (605)—This red push button is used to shut down burner operation. If desired, the circulation and exhaust blowers and the conveyor drive system will continue to operate until the interior of the heat chamber reaches 150° F. This allows the interior of the dryer to cool down properly before automatically shutting down.

Emergency Stop Push Button (606)—This red colored push button is used to immediately shut-down operation of the gas burner in the event of an emergency situation. To de-activate the Emergency Stop push button, one pulls it gently Out.

Audible Alarm Signal (800)—Attached or adjacent the control panel 600 is a speaker 800, an audio alarm system. In the event that the burner flame detection system does not sense the presence of the burner flame, or if the infrared temperature sensors (200), or internal heat chamber thermocouple (100) detects insufficient or excessive temperature, this audible signal will sound.

Reset Push Button (607)—In the event that the burner flame detection system does not sense the presence of the burner flame for any reason, the flame safeguard control will automatically send the system into a “flame failure” mode. Whenever the system detects a “flame failure” condition, the audible alarm signal will sound. The Reset button can reset the system if necessary after such a condition.

Touch Screen (601)—This is a user friendly touch screen operator interface with LCD display for the control of temperature, conveyor belt speed, control system monitoring and diagnostic messages. Upon application of control power to the equipment, the LCD will display the “Main” menu message screen. This screen displays the manufacturer's logo and two smaller indicator boxes marked “INFO” and “MENU.” Pressing the “INFO” indication will display the “INFO” message screen. The “INFO” message screen displays contact information for the manufacturer, including a 24 hour Emergency Service and Support phone number. Pressing the “MENU” indication results in the “Menu” screen being displayed (FIG. 4).

Tower Light (700)—The tower light is green and provides a visual indication of the dryer's operation at a distance. When green, the dryer is operating properly and the conditions read by the outfeed sensors 200 are within preselected acceptable range(s). The light may also illuminate different colors (e.g., orange/amber and/or red) whenever the present temperature inside the dryer chamber (sensed by sensor 100) is insufficient or excessive. The light also illuminates colors other than green (such as orange/amber and/or red) whenever a diagnostic problem occurs (e.g., the burners are sensed to have gone off) or the temperature of the ink (sensed by the infrared outfeed temperature sensors 200) are outside of a preselected range for a preselected period of time. In the event the temperature exceeds or falls below the pre-set temperature setting for the outfeed temperature sensors 200, the tower light will extinguish and an audible alarm 800 will signal a sound. In the alternative and/or in addition, the light can turn orange/amber for a “Orange/Amber Condition” and can turn red for a “Red Condition.” It should be known that while the tower light is noted as being green while the system is working within the prescribed and selected parameters, in the alternative, the tower light may be off for such green conditions.

To operate the system, one opens the manual shut-off valve 76 located at the gas supply inlet 70 to the dryer. The green push button 602 marked “On” under “Start Dryer” is pushed, followed by the pushing in of the green push button 604 marked “On” under “Start Burner.” To shut the dryer off, one pushes the red “Off” push button 605 under “Start Burner” followed by pushing the red “Off” push button 603 under the “Start Dryer” section of the control panel 600. Upon activation, the circulation blower and conveyor belt drive will continue to operate until the internal temperature in the heat chamber reaches 150° F. When the internal heat chamber temperature reaches 150° F., the circulation blower and the conveyor belt drive will automatically stop.

The main menu for the touch screen 601 of the control unit 600 is shown in FIG. 5 and is a starting point for controlling the parameters of the system, including “MONITOR 1” for controlling the chamber sensor 100, “MONITOR 2” for controlling the delivery sensor(s) 200, “ALARMS” for controlling the alarm conditions, “GRAPH” for displaying relevant graphs, “RECIPE” for storing and recalling programs or job settings, “MAIN” for viewing the main screen with manufacturer information and contact information, “G.USAGE” for reviewing the gas consumption, and “TEST” for running diagnostic tests.

The “TEST” menu is used as a “on-board” diagnostic indicator which can be used to confirm the operational status of all switches used to operate the dryer. To access the “TEST” menu, one touches the “TEST” indicator box in the upper right corner of the Menu message screen. (FIG. 5). This will display the “TEST” message screens with indicator lights (not shown). These indicator lights are used to display the operational condition of each of the items (switches) displayed.

The Chamber Sensor(s) 100

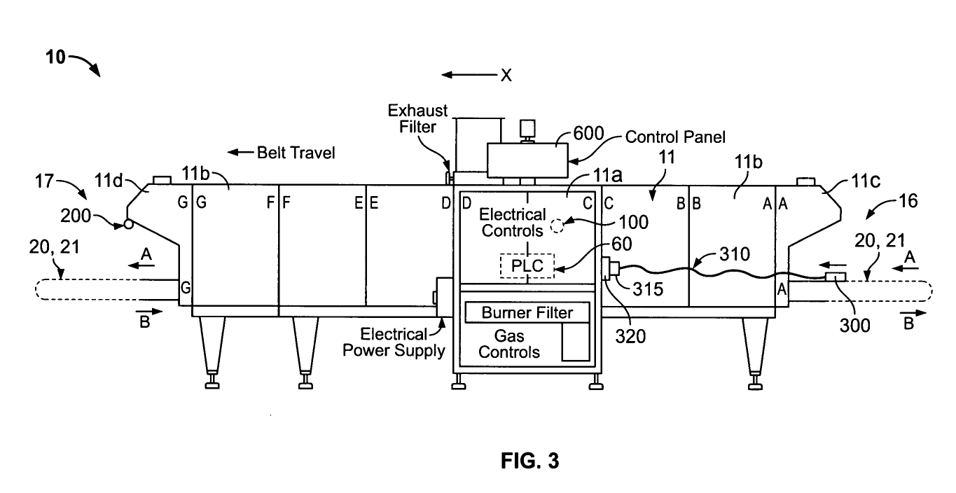

Within the chamber, a sensor or set of sensors is secured, namely a chamber sensor(s) 100. This is shown schematically in FIG. 3. Typically, this chamber sensor(s) is a thermocouple attached within the housing 11 above the belt 20 and burners ideally midway between the chamber's inlet 16 and outlet 17 to sense and read the internal chamber temperature of the dryer 10. This chamber sensor(s) 100 is preferably a thermocouple for continuously monitoring, reading and tracking the chamber temperature over time above the belt 20. This specifically allows one to monitor the temperature within the chamber. One preferred sensor is a thermocouple Type K probe (with Type K plug and using a Type K socket/receptacle). A standard mounting flange is used to mount or install it within the chamber.

A typical temperature profile over time generated from readings by the chamber sensor(s) 100 shows the actual chamber temperatures and changes thereto. See, for example, FIGS. 13 and 14. The setting and readings (feedback) are fed into the PLC so that the PLC can adjust the burners and/or blowers to bring the actual temperature readings in-line or closer to the set temperatures. In addition, if the temperature within the chamber sensed by the internal sensor(s) 100 is insufficient or excessive (set by default by the system or pre-set by the operator or a program), the PLC system can trigger a visual and/or audio alarm.

Monitor 1

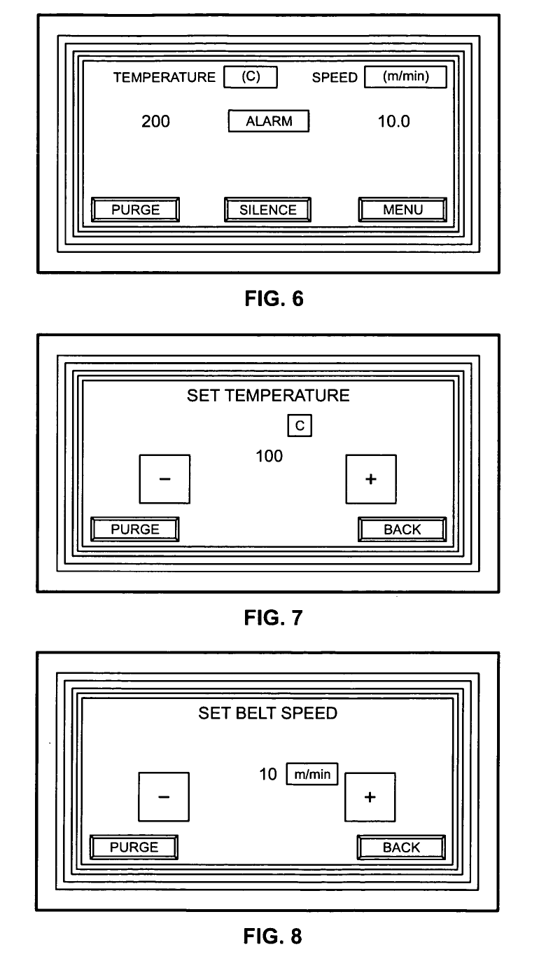

Touching the screen 601 for “MONITOR 1” on the menu shown in FIG. 5 brings up the temperature and belt speed display screen. (FIG. 6) The Monitor 1 message screen displays the present temperature inside the heat chamber 18 on the left side of the message screen. The current speed of the conveyor belt 20 is displayed on the right side of the message screen. The temperature and belt speed may be displayed in either Fahrenheit or Celsius, or feet per minute, or meters per minute.

To adjust the temperature, one touches the numerical indication for the current temperature displayed at the left of the message screen. This will display the Set Temperature message screen. (See FIG. 7). The Set Temperature message screen displays the present temperature setting in the center of the display. To the left is a small icon box with a minus (−) sign and to the right is another icon box with a plus sign (+). To increase the present temperature, one touches the plus (+) icon. Each time one touches the plus (+) icon box, the present temperature will increase by 1 degree. If one touches the plus (+) icon box and leaves his/her finger on the box, the indication for the temperature setting will rapidly increase. The maximum setting for the present temperature is 450° F. (230° C.). To decrease the present temperature, one touches the minus (−) icon in a similar fashion to that described above with respect to the plus (+) icon.

Touching the BACK icon at the lower right corner of the Set Temperature message screen will return the screen to the MONITOR 1 message screen.

Conveyor Belt Speed

The Monitor 1 message screen displays the current conveyor belt speed on the right side of the message screen. To adjust the conveyor belt speed, one touches the indication for the conveyor belt speed. This action will display the Set Belt Speed message screen. (See FIG. 8). The Set Belt Speed message screen displays the current conveyor belt speed setting in the center of the display. To the left is a small icon box with a minus (−) sign and to the right is another icon box with a plus sign (+). To increase or decrease the conveyor belt speed, one touches the plus (+) icon or the minus (−) icon. The maximum setting for the conveyor belt speed is 55 feet per minute (16.7 meters per minute).

The Outfeed Sensor(s) 200

As shown schematically in FIG. 3, one or more outfeed sensors 200 are positioned outside of exit opening 17 above the belt 20 to sense and read the outfeed temperature of an article emerging from the heating chamber of the dryer 10 on the belt 20. The outfeed sensor(s) 200 is preferably an infrared sensor for continuously monitoring, reading and tracking the absorption temperature over time on the belt 20. This specifically allows one to specifically monitor the temperature of the substrate (e.g., textile) traveling on the belt and/or the temperature of the ink placed on the substrate and the temperature of the belt (e.g., between substrates) as they pass under the sensor(s) 200. Of most importance is the measuring and monitoring of the ink absorption temperature. Preferred sensor(s) are infrared Type K probes (with Type K plug and using a Type K socket/receptacle).

It is well recognized that substrates come in different sizes. As such, it is important that the sensors be movable relative to the belt so that they can be positioned directly over substrates passing thereinunder out of the unit.

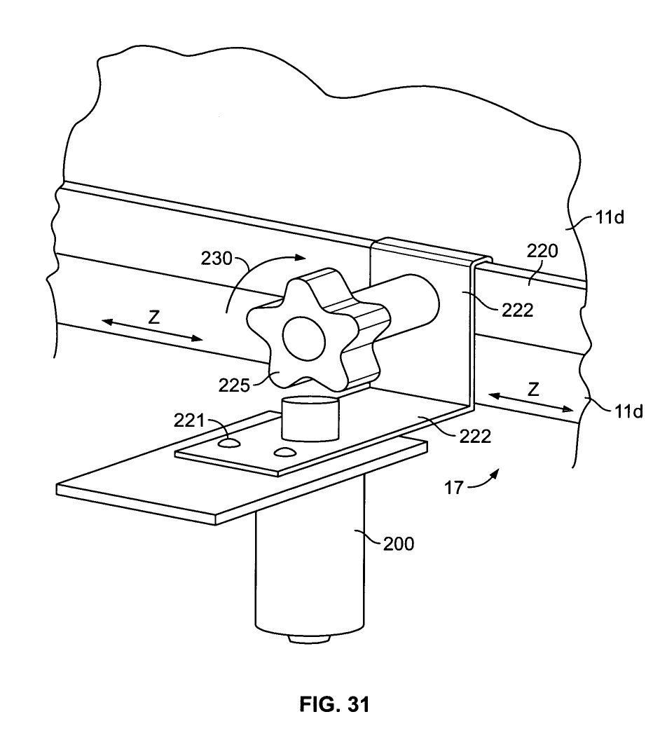

FIG. 31 generally shows an outfeed sensor 200. A substantially horizontal slot 220 is positioned above the outfeed opening 17 of the unit 10. Each sensor 200 is connected via screws 221 to an L-shaped bracket 222. The L-shaped bracket sits behind the slot 220 and has either a seat built therein or equivalent that accepts the threaded stud of a thumb screw 225. The thumb screw 225 can be loosened and the sensor slid along the slot (Directions Z) and then tightened once the sensor is in position. The set-screw 225 frictionally engages the wall 11d of the unit 11 and slot 220 and holds the L-shaped bracket 222 against the wall with the slot within the rail and can be selectively locked into a position along the rail. The wires 230 from the sensor 200 plug into receptacles (not shown) adjacent the unit. As such, each sensor can be moved along the slot 220 to position it directly above the substrates passing through the unit and out the exit opening or delivery end 17 of the housing.

Monitor 2

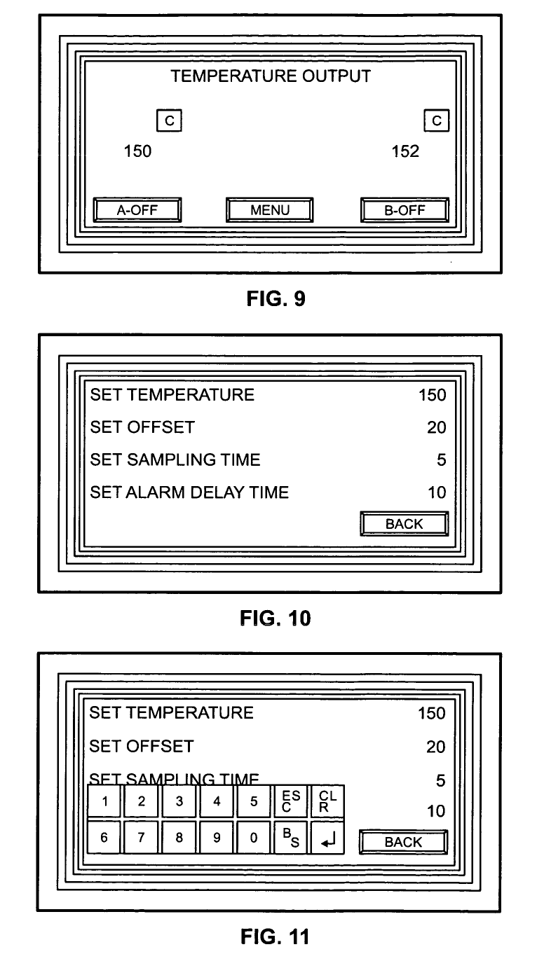

Pressing the “MONITOR 2” indicator in the upper right corner of the display will bring up the infrared temperature sensor displays for both the “A” and “B” temperature sensors (assuming two sensors (Sensor A and Sensor B) are used at the outfeed) located at the out feed end of the dryer. (See FIG. 3). Again, these temperature sensors monitor the surface temperature of substrates (e.g., garments) as they exit the dryer chamber. The temperature is then displayed in the Monitor 2 screen as shown in FIG. 9. Both the “A” and “B” infrared temperature sensors may be independently activated using the ON/OFF icons located below each temperature display. To activate either sensor one merely touches the ON/OFF icon to toggle the indication from ON to OFF or vice versa. The display may be set to indicate either Fahrenheit or Celsius.

The substrate's surface temperature which the infrared sensors track, may be selected by the operator by either touching the right or the left temperature indication. The screen will then display the SET message screen. (See FIG. 10). The message screen illustrated shows SET TEMPERATURE, SET OFFSET, SET SAMPLING TIME and SET ALARM DELAY TIME.

To set the SET TEMPERATURE selection, one touches the numerical indication at the extreme right of SET TEMPERATURE. A flashing cursor will appear over the numerical value and a numerical keyboard will be displayed at the bottom left of the message screen. (See FIG. 11). In the example illustrated, the SET TEMPERATURE has been set to 150° F. To duplicate this setting, one touches first the number 1 on the keyboard, then the number 5 and finally the number 0. One next touches the Return/Enter key to lock in the selection for SET TEMPERATURE.

Turning again to FIG. 10, the SET OFFSET selection below the SET TEMPERATURE selection is used to set the range of the SET TEMPERATURE setting. In other words, if one has selected 290° F. for the SET TEMPERATURE, and the SET OFFSET is selected to 20° F. as illustrated, the infrared sensors 200 will be looking for a substrate surface temperature of between 270° F. and 310° F., representing a plus or minus range of 20F. One can adjust the SET OFFSET selection in the same manner previously described for SET TEMPERATURE.

The next selection is SET SAMPLING TIME. This setting is used to set a dwell time for the infrared sensors 200 as they look at the surface temperature of the substrate exiting the dryer chamber. For example, in the illustration above, the SET SAMPLING TIME has been set for 5 seconds. This means that the infrared sensors look at the surface of the substrates exiting the dryer chamber every 5 seconds. One can adjust the SET SAMPLING TIME selection in the same manner previously described for SET TEMPERATURE and SET OFFSET.

The ink absorption temperature can also be visually monitored or stored by displaying and capturing the data of temperature readings by the sensor 200. FIG. 30 shows a typical temperature profile over time generated from readings by the outfeed sensor(s) 200. The profile will generally be a repeating pattern having a base temperature (A), a spike temperature or high temperature (B), and a plateau temperature (C). Generally, the base temperature (A) reflects the temperature of the belt, the spike temperature (B) reflects the temperature of the ink being cured on the substrate and the intermediate plateau temperature (C) reflects the temperature of the substrate traveling under the sensor(s) 200.

It has been found that with belts 20 having a width of less than 48″, one outfeed sensor is adequate; with belts having a width of between 48″ and 60″, two outfeed sensors 200 are preferred; and with belts having a width of 72″, three outfeed sensors are preferred.

Alarm System 700

Proper running and alarm conditions can be set around pre-selected parameters by an operator or by a program previously stored or recalled. These conditions can be monitored by the PLC and indicators generated therefrom. In particular, if the temperature sensed by the outfeed sensor(s) 200 is outside of a desired range for a preset amount of time (e.g., proper running conditions) (ALARM DELAY TIME 1 and ALARM DELAY TIME 2), an alarm can be triggered, both audio and visual. Specifically, the operator can program into the controller 600 via the touch screen 601 proper running conditions (green), warning conditions (orange/amber), and problem conditions (red) associated with the curing necessary for the ink employed on the substrate. An example might be that proper running conditions for curing a particular ink on a particular substrate are 290° F. for 2 minutes. Warning conditions may be when the temperature varies more than 10° F. above or below this amount and the time the out-of-range temperature is greater or less than 10 seconds from 2 minutes. A problem condition is anything outside of this range, that being 290° F.±10° F. and 2 minutes±10 seconds.

It should be recognized that both the ink being employed and the substrate being printed upon affect the proper conditions necessary for properly curing the ink. Specifically, different inks require different temperatures and curing times and different substrates, or textiles, affect the temperatures and times needed.

The operator can also program whether such warnings are to be audio, visual or both. For this purpose, an alarm 700 is mounted above the housing in a conspicuous location for both displaying visual conditions via a light (green, orange/amber and red) and/or sounding audio conditions 800 (one alarm sound for warning conditions (orange/amber) and another alarm sound for problem conditions (red)). In addition, or in the alternative, the touch screen 601 can change colors (orange/amber and red) upon certain warning conditions. Accordingly, an operator can look to the unit 10 and at the alarm 700 and see the unit 10 is operating in proper conditions (continuous green light and no alarm), under a warning condition (flashing orange/amber light and an audio first alarm), or in a problem condition (flashing red light and an audio second alarm) and take the necessary steps, if any.

Thus, once the conditions are set via the controller 600, the PLC takes the temperatures read by the outfeed sensor(s) 200 and compares them to the settings. If the temperatures fall within one of the set ranges, a signal is generated reflecting the state (green, orange/amber or red) alerting the operator.

In the SET TEMPERATURE screen (FIG. 10), both the time delays for an orange/amber alert condition and a red alert condition can be set. The SET ALARM DELAY TIME 1 is used to set the delay time before the first orange/amber flashing alarm (light, screen, and/or speaker) indication is activated. The orange/amber flashing alarm will be displayed in the event that the infrared sensors do not detect the pre-set surface temperature (within the range established by the SET OFFSET amount) of an exiting substrate.

One can adjust the SET ALARM DELAY TIME 1 selection in the same manner previously described for SET TEMPERATURE and SET OFFSET. (FIG. 11). Accordingly, in the example above, an alarm condition (orange/amber) will exist if the sensed temperature is outside the range 290° F.±10° F. for 10 seconds. It should be noted that if an operator will be stopping frequently to replenish ink, textiles, etc., the SET SAMPLING TIME should be set for additional time to complete these tasks and avoid nuisance alarms.

The SET ALARM DELAY TIME 2 is used to set the delay time before the second, red flashing alarm (light, screen, and/or speaker) indication is activated. The red flashing message alarm will be displayed in the event that the operator fails to respond to the first orange/amber flashing alarm.

One can adjust the SET ALARM DELAY TIME 2 selection in the same manner previously described for SET TEMPERATURE and SET OFFSET.

Each infrared temperature sensor 200 may be independently activated using the ON/OFF icons located below each temperature display. To activate either sensor simply touch the ON/OFF icon to toggle the indication from ON to OFF or vice versa.

If during the orange/amber alert mode the sensors begin to read the set temperature, the orange/amber alert will automatically reset itself. If the orange alert continues beyond the set delay time, the red colored alarm mode will activate.

Because the purpose of the infrared sensors 200 is to monitor the surface temperature of substrates as they exit the dryer, in the event that any one of the sensors fails to detect a substrate, the alarm indications will be triggered and activated. This is intended to alert the operator that no garments are exiting the dryer chamber.

There are two specific flash modes used for alerting the operator to this condition. The first flash mode produces an orange/amber colored alert/alarm. The second flash mode produces a red alert/alarm. The orange/amber alert/alarm is designed to display an initial alert while the red is designed to indicate a more urgent alert. Each of these flash modes can be programmed to flash for a specified time period to allow the operator a suitable time to respond.

A typical scenario might develop when one or more infrared sensors 200 fails to detect substrates exiting the dryer chamber. As a result, the alert/alarm will begin to flash or sound an orange/amber alarm (either the screen, light and/or speaker). After a pre-determined delay time (which is programmed by the operator), the alert/alarm will begin to flash or sound a red alarm (either the screen, light and/or speaker).

Graphs

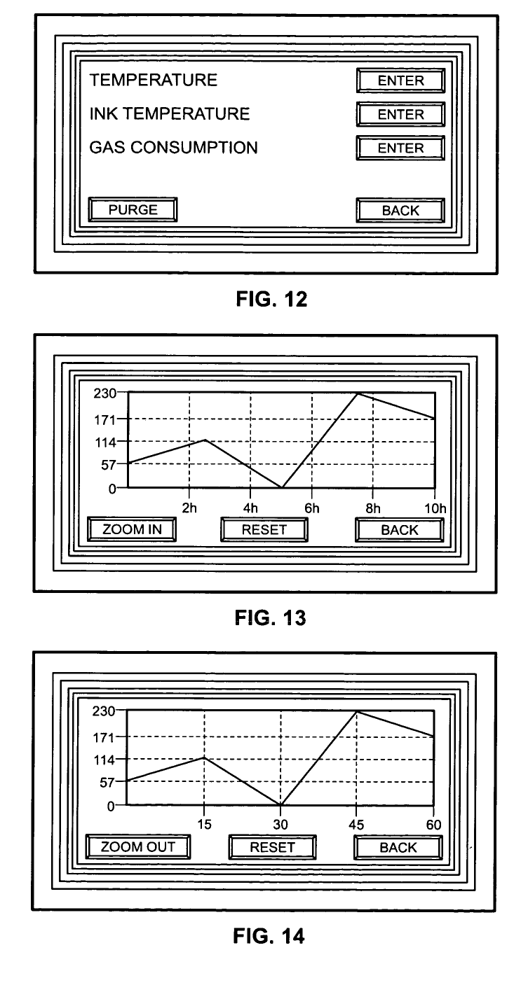

Using the “GRAPH” menu, the operator can determine at a glance the dryer performance over a given time period. The “GRAPH” menu selection (FIG. 12) displays graphic representations for the monitoring of temperature, ink temperature and gas consumption. This information is valuable in determining energy usage, dryer efficiency and system performance. To access the “GRAPH” menu selection, one touches the “GRAPH” indication in the middle left of the second menu message screen. (See FIG. 5). This will display the “GRAPH” menu message screen which includes “TEMPERATURE,” “INK TEMPERATURE,” and “GAS CONSUMPTION.” One touches the ENTER icon box at the right of TEMPERATURE.

The first menu selection in the “GRAPH” menu is “TEMPERATURE” which displays a visual history of the dryer's temperature over a ten hour time period as sensed by the chamber sensor(s) 100. The temperature is read along the vertical line at the left of the graph, and the time is read along the horizontal line at the bottom of the graph. In the example of FIG. 13, the temperature history screen, the dryer temperature started at approximately 60° C. (140° F.). Over the course of the first two hours of production, the temperature increased to 114° C. (237° F.). At the start of the second hour and through to the fourth hour, the temperature decreased from 114° C. (237° F.) to approximately 20° C. (68° F.).

The “ZOOM IN” indicator box in the lower left corner of the message screen permits one to change the time from hours to minutes. See FIG. 14.

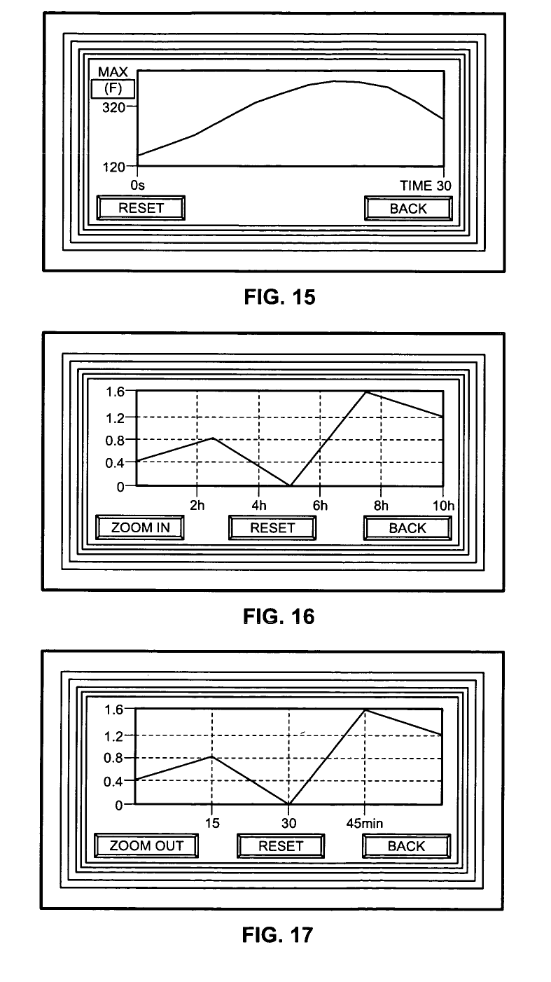

The “INK TEMPERATURE” graph is used in the same manner as described for the TEMPERATURE graph. When the remote thermocouple probe 300 is placed on a substrate passing through the dryer, the surface temperature of the ink is displayed along the vertical line at the left of the message screen. As with the temperature graph, a time reference line is provided along the bottom horizontal line of the graph and is graduated in seconds. For example, in the illustration below we can see that the ink temperature achieved the maximum temperature of 320° F. (160° C.) in 30 seconds time. (See FIG. 15). Touching the “RESET” indicator in the lower left corner of the message screen clears the temperature display before sending the product with the temperature probe into the dryer chamber.

One touches the “BACK” indicator box in the lower right corner of the message screen to return to the “GRAPH.”

The “GAS CONSUMPTION” graph is used in the same manner as described for the temperature graph. The use of gas energy is displayed along the vertical line at the left of the message screen. The graph is broken down into percentages of “0,” “25,” “50,” “75,” and “100” percent efficiency. As with the temperature graph, a time reference line is provided along the bottom horizontal line of the graph. (See FIG. 16). As shown, one can see that for the first two hours of operation the dryer consumed between 0.4 and 0.7 BTU's of gas. Gas consumption then fell back during the next two hours to 0.4 BTU's. As with the temperature graph, one can touch the “ZOOM IN” indicator in the lower left corner of the graph message screen to change the time line from hours to minutes. (See FIG. 17).

Gas Usage

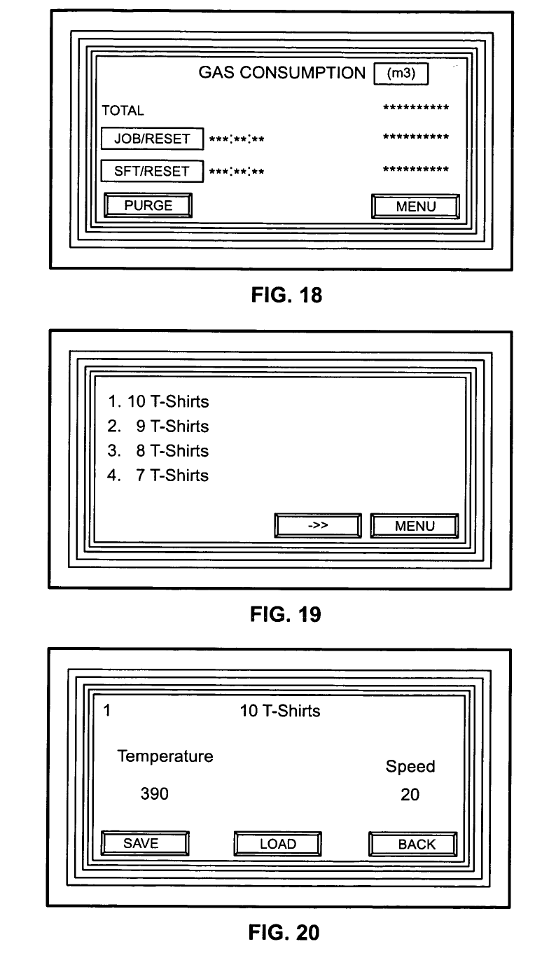

The system monitors and displays gas usage in the Gas Usage message screen. To access the Gas Usage message screen, touch the G.USAGE icon at the middle right of the MAIN menu screen. (See FIG. 5). The Gas Usage message screen displays the gas consumption based on a per job or per shift basis. The screen also displays total gas consumption at the top of the message screen. The Job and Shift displays may be reset simply by touching the word “RESET” on the message screen. The Total indication is not able to be reset and is provided as a indication of total gas usage. (See FIG. 18). As with the previous message screens described in this section, the gas usage may be adjusted to display either CF (cubic feet) or m3 (cubic meters) units of measure.

Touching the MENU icon in the lower right corner returns the screens to the MAIN message screen.

Recipes

The system also permits one to store in the control memory parameters for temperature settings and conveyor belt speeds for specific drying applications. For example, if one runs a wide range of products such as sweats, 100% cotton t-shirts, long sleeve shirts or a combination of materials and ink systems, one can store this information in one of many recipe menus for use when that particular drying application is required once again.

A total of thirty (30) recipes may be stored for a single belt machine or fifteen (15) recipes per belt for dual (side-by-side) belt machines.

The storage of jobs or recipes greatly facilitates setting-up the machine and notably increases efficiency. Generally, one can create recipes based upon the type of textile or garment and the type of ink. For example, a first recipe may be to: garment=white/100% cotton/t-shirt; ink=plastisol #12. A second recipe may be to: garment=colored/60% cotton-40% nylon/sweatshirt; ink=plastisol #8.

By touching the “RECIPE” indicator box at the lower left of the message screen, one will call up the “RECIPE” message screen. (See FIG. 5).

FIG. 19 shows the screen of the first “RECIPE” message screen which lists four recipe storage areas. Touching the “NEXT SCREEN” (-->) indicator to the left of the “MENU” indicator at the bottom of the message screen displays additional “RECIPE” message screens. The additional “RECIPE” message screens include four more recipe areas for a total of thirty. One touches the “PREVIOUS SCREEN” (<--) indicator box at the lower left of the message screen to return to the first recipe message screen.

One can load existing recipes or new recipes into the system via the touch screen 601. For example, to load an existing recipe, one touches the box marked “1” in the upper left corner of the first “RECIPE” message screen. (FIG. 19). This brings up the recipe data screen. In the example of FIG. 20, the screen indicates that the recipe is for “10 T-Shirts,” that the temperature setting is 390° F. and the conveyor belt speed is 20.0. If one wishes to use these drying parameters, one touches the “LOAD” indicator box at the lower middle of the message screen and the temperature and conveyor belt speed will be automatically set to these specific parameters.

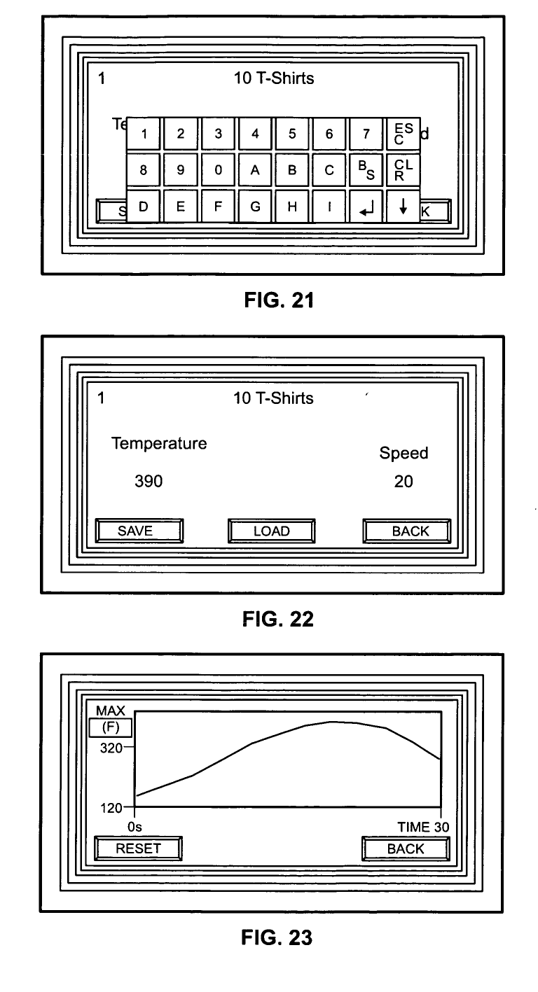

One can also create and store a recipe by touching the “1” in the first recipe message screen. (FIG. 19). This will call up an alpha/numeric keyboard which is used to enter the identifier name for the recipe, for example “10 T-Shirts.” (See FIG. 21). Using the letter and/or number keys, enter the name of the recipe. Touch the “Enter/Return” key at the bottom right of the message screen to enter the identifier name for the recipe. This will automatically return one to the first recipe message screen. Next, one touches the “SAVE” indicator at the lower left corner of the message screen. (FIG. 22). The settings and name for the first of twenty-eight recipes are now stored in the system memory. The settings for the temperature and conveyor belt speeds as they are currently set on the dryer, will automatically be saved and stored along with the recipe name.

The Running Thermocouple (Infrared Temperature Probe) 300

There is a specific receptacle/plug-in 320 on the side of unit adjacent the controls for donut thermocouple 300. When the donut thermocouple or infrared temperature probe 300 is in communications with the unit, via the plug-in feature, the data generated by the thermocouple can be downloaded, read and interpreted by the PLC and displayed on the system's screen 601. Again, one preferred sensor is a thermocouple probe, a Type K probe (with Type K plug and using a Type K socket/receptacle). The donut thermocouple 300 rides on top of a textile resting on the belt 20 as the textile travels into, through and out of the dryer. The surface temperature of the ink can be monitored and displayed on the touch screen operator interface screen 601.

It should be noted that anything stored on the PLC, generated by the PLC or displayed on the screen can be printed out for archival or further reference later. A conventional printer would be linked to the system, or controller, by conventional, well-known means for such a purpose.

To access the “GRAPH” menu selection, one touches the “GRAPH” indication in the middle left of the menu message screen. (See FIG. 5). This will display the “GRAPH” menu message screen which includes “TEMPERATURE,” “INK TEMPERATURE” and “GAS CONSUMPTION” indications (See FIG. 12). Touching the ENTER icon box at the right of INK TEMPERATURE brings up the graphs discussed below. The “INK TEMPERATURE” graph is used to display the surface temperature of the ink film as the garment passes through the dryer chamber. When the remote thermocouple probe 300 is placed on a garment, the surface temperature of the ink is displayed along the vertical line at the left of the message screen. As shown in FIGS. 23-26, a time reference line is provided along the bottom horizontal line of the graph and is graduated in seconds. The vertical line on the left indicates the temperature in degrees Fahrenheit or Celsius, whichever is selected. For example, in the illustration of FIG. 23, the ink temperature achieved the maximum temperature of 320° F. in 30 seconds time.

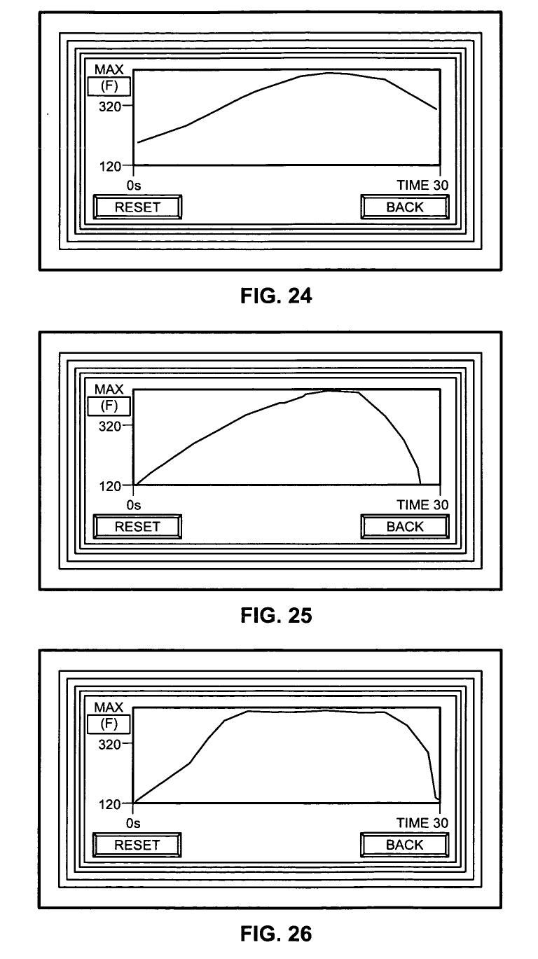

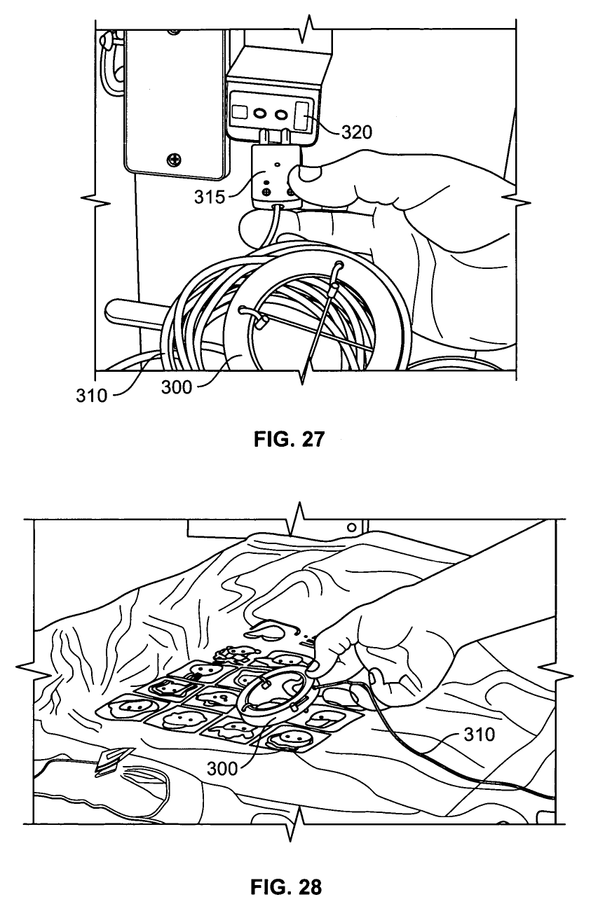

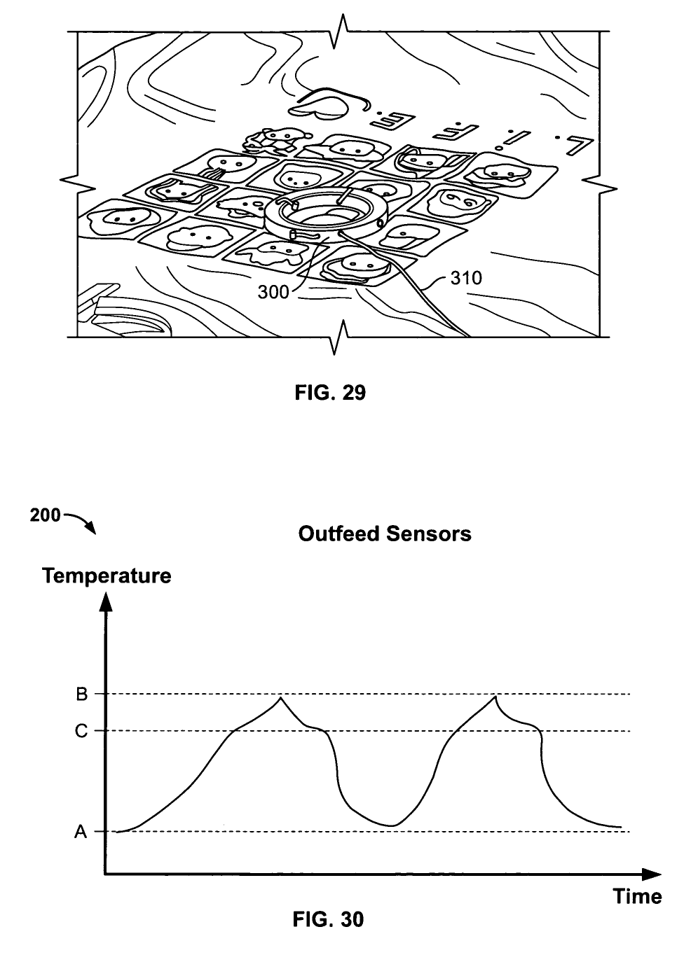

After connecting the infrared temperature probe's 300 plug 315 (preferably a Type K plug) into the plug socket/receptacle 320 (preferably a Type K socket/receptacle) located at the lower left side of the heat chamber 18 (FIG. 27), the probe sensor wire 310 is un-coiled to its full length. The circular probe is placed on the garment over the image area to be monitored with the thin cross wires on the probe facing down, touching the garment surface. (FIGS. 28 and 29). The “RESET” indicator in the lower left corner of the message screen (FIG. 23) is touched to clear the temperature display before sending the product with the temperature probe into the dryer chamber 18. The substrate is allowed to proceed through the dryer chambers 11,18 with the temperature probe 300. As the garment together with the temperature probe 300 pass through the dryer chamber 18, one carefully feeds the temperature probe wire 310 through the dryer chamber in-line with the garment. One may allow the temperature probe to pass completely through the dryer chamber provided the probe is unplugged from its socket/receptacle 320 after the probe has exited the dryer chamber 18. One may also gently pull the probe back through the dryer chamber after it has completely passed through the chamber. Then one unplugs the probe and sets it aside. (See FIG. 24).

As the infrared probe 300 passes through the dryer heat chamber 18 the INK TEMPERATURE graph will display the ink temperature. A typical reading would be a gradual increase in ink temperature from “0” degrees to 325° F. and then immediate decrease in temperature as the garment exits the dryer chamber. This would be an indication of proper exposure time and/or conveyor belt speed. (See FIG. 25).

An example of excessive exposure time, or slower conveyor belt speed would appear as illustrated in FIG. 26.

With the present system, one can monitor and adjust the actual ink temperature of the traveling textile(s) by: 1) Setting temperature and belt speed; 2) Running the thermocouple probe 300 through the oven chamber on the textile riding on the belt; 3) Reviewing the data or graph in real-time on the monitor; 4) Optimizing the oven chamber and belt speed (by using the controller's touch screen); 5) Checking the new settings by running the thermocouple probe 300 through the oven chamber again and adjusting the oven chamber and belt speed if necessary; and, 6) Setting parameters into memory of PLC as a recipe for later call-back.

While the specific embodiments have been illustrated and described, numerous modifications are possible without significantly departing from the spirit of the invention and the scope of protection is only limited by the scope of the accompanying Claims.

APPENDIX A
PLC

| EXTERNAL ITEM | INPUT | COMMENTS | INSIDE PLC | OUTPUT | COMMENTS |
|---|---|---|---|---|---|
| SENSOR 100 | | | | | |
| Sensor 100 | Temp. (Reading) | Sensed Temp. by | Information Received | Displayed as | Information |
| (within Housing 11) | from Sensor 100 | Sensor 100 | by PLC | Number and/or | Stored for Recall |
| | | | | Graph (over | Later (History) |
| | | | | Time) on | |
| | | | | Controller or | |
| | | | | Printer | |
| Touch Screen 601 on | Temp. Control for | This is the | Comparison Performed | Adjustment to | |
| Control Panel 600 | Internal Chamber 18 | Preferred | by PLC of Temp. | System Made to | |
| | (Setting) | Operating | Setting and Sensed | bring Internal | |
| | Setting Adjusted by | Conditions for | Temp. | Chamber Temp. | |
| | Operator or Pre-Stored | Unit and | | to Temp. | |
| | Program | Textile(s) | | Setting | |
| | | | Comparison Performed | Alert-Alarm | Visual and Audio |
| | | | by PLC of Temp. | Displayed | Alert-Alarm if |
| | | | Setting and Sensed | Orange/Amber | Desired |
| | | | Temp. and Range | or Red if Out of | |
| | | | (Defining Insufficient | Preselected or | |
| | | | or Excessive Heat) Pre- | Default Range | |
| | | | Set by Operator or Pre- | | |
| | | | Store Program or as | | |
| | | | Default in Unit | | |
| SENSOR 200 | | | | | |
| Sensor 200 | Temp. (Reading) from | Sensed Reading | Information Received | Displayed as | Information |
| (1-3 Sensors at Exit 17 of | Sensor 200 | by Sensor 200 | by PLC | Number and/or | Stored for Recall |
| Housing 11) | | | | Graph (over | Later (History) |
| | | | | Time) on | |
| | | | | Controller or | |
| | | | | Printer | |
| Touch Screen 601 on | Temp. Control for | This is the | Comparison Performed | See “Alarm | |
| Control Panel 600 | Outfeed Sensor 200 | Preferred | by PLC of Temp. | Conditions” | |
| | (Setting) | Operating | Setting, Sensed Temp., | Below | |
| | Setting Adjusted by | Conditions for | and Dwell Time(s) | | |
| | Operator or Pre-Stored | Unit, Textile(s) | | | |
| | Program | and Ink | | | |
| SENSOR 300 | | | | | |
| Traveling Sensor 300 | Temp. (Reading) from | Sensed Temp. by | Information Received | Displayed as | Information |
| | Sensor 300 | Sensor 300 | by PLC | Number and/or | Stored for Recall |
| | | | | Graph (over | Later (History) |
| | | | | Time) on | |
| | | | | Controller or | |
| | | | | Printer | |
| ALARM CONDITIONS | | | | | |
| Touch Screen 601 on | Temp. Range | Default | Information Received | Displayed as | Setting Can Be for |
| Control Panel 600 | Green Condition | Condition When | by PLC | Number or | Visual and/or |
| | (Default) | Neither | | Range on | Audio Alert- |
| | | Orange/Amber | | Touch Screen | Alarm |
| | | Condition or Red | | 601 on Control | |
| | | Condition | | Panel 600 | |
| Sensor 200 | Temp. (Reading) from | Sensed Temp. by | Comparison Performed | Alert-Alarm | Visual and Audio |
| (1-3 Sensors at Exit 17 of | Sensor 200 | Sensor 200 | by PLC of Temp. | Displayed | Alert-Alarm if |
| Housing 11) | | | Setting, Dwell Time(s) | Green if Within | Desired |
| | | | sand Sensed Temp. | Temp. Setting | |
| Touch Screen 601 on | Temp. Range | This is the First | Information Received | Displayed as | Setting Can Be for |
| Control Panel 600 | Orange/Amber | Dwell Time (1) | by PLC | Number or | Visual and/or |
| | Condition | Setting | | Range on | Audio Alert- |
| | (Setting) | | | Touch Screen | Alarm |
| | Dwell Time 1 Setting | | | 601 on Control | |
| | Adjusted by Operator | | | Panel 600 | |
| | or Pre-Stored Program | | | | |
| Sensor 200 | Temp. (Reading) from | Sensed Temp. by | Comparison Performed | Alert-Alarm | Visual and Audio |
| (1-3 Sensors at Exit 17 of | Sensor 200 | Sensor 200 | by PLC of Temp. | Displayed | Alert-Alarm if |
| Housing 11) | | | Setting, Dwell Time(s) | Orange/Amber | Desired |
| | | | and Sensed Temp. | if Out of | |
| | | | | Preselected | |
| | | | | Green Range | |
| | | | | for Dwell Time 1 | |
| Touch Screen 601 on | Temp. Range | This is the | Information Received | Displayed as | Setting Can Be for |
| Control Panel 600 | Red Condition | Second Dwell | by PLC | Number or | Visual and/or |
| | (Setting) | Time (2) Setting | | Range on | Audio Alert- |
| | Dwell Time 2 Setting | | | Touch Screen | Alarm |
| | Adjusted by Operator | | | 601 on Control | |
| | or Pre-Stored Program | | | Panel 600 | |
| Sensor 200 | Temp. (Reading) from | Sensed Temp. by | Comparison Performed | Alert-Alarm | Visual and Audio |
| (1-3 Sensors at Exit 17 of | Sensor 200 | Sensor 200 | by PLC of Temp. | Displayed Red | Alert-Alarm if |
| Housing 11) | | | Setting, Dwell Time(s) | if Out of | Desired |
| | | | and Sensed Temp. | Preselected | |
| | | | | Green Range | |
| | | | | for Dwell Time 2 | |
| GAS CONSUMPTION | | | | | |
| Gas Meter 72 Attached to | Gas Meter 72 Reading | This is the Unit's | Information Received | Displayed as | Information |
| Gas Regulator 71 for | of Actual Gas | Gas Usage | by PLC | Number and/or | Stored for Recall |
| Housing 11 | Consumed | | | Graph (over | Later (History) |
| | | | | Time) on Touch | (Actual Gas |
| | | | | Screen 601 on | Consumption) |
| | | | | Control Panel | |
| | | | | 600 or Printer | |
| BELT SPEED | | | | | |
| Touch Screen 601 on | Belt Speed Control for | This is the | Information Received | Displayed as | Information |
| Control Panel 600 | Belt 20 | Desired Speed of | by PLC | Number and/or | Stored for Recall |
| | (Setting) | the Belt(s) | | Graph (over | Later (History) |
| | Setting by Operator or | | | Time) on Touch | |
| | Pre-Stored Program | | | Screen 601 on | |
| | | | | Control Panel | |
| | | | | 600 or Printer | |
| Counter on Belt, Motor | Belt 21 Speed Reading | Setting by | Information Received | Displayed as | Information |
| for Belt or Roller | of Actual Belt Speed | Operator Same | by PLC | Number and/or | Stored for Recall |
| | | as Actual Belt | | Graph (over | Later (History) |
| | | Speed | | Time) on Touch | |
| | | | | Screen 601 on | |
| | | | | Control Panel | |
| | | | | 600 or Printer | |

1. A dryer for textiles having a heating chamber with an input opening and an exit opening and a mechanism for moving the textiles through the input opening and heating chamber and out the exit opening, comprising:
at least one detector sensing temperature inside the chamber;
a controller receiving the sensed temperature and displaying and/or printing the sensed temperature over time.

2. The dryer as claimed in claim 1 further including an alarm system associated with the controller for visually and/or audibly alerting an operator when the sensed temperature is outside a pre-defined temperature range.

3. The dryer as claimed in claim 1 wherein the controller stores at least one set of dryer settings associated with the dryer for recalling and applying to the dryer,
each set of dryer settings including:
a chamber temperature setting; and,
a speed setting for the mechanism moving the textiles.

4. The dryer as claimed in claim 3 further including an alarm system associated with the controller for visually and/or audibly alerting an operator when the sensed temperature is outside a pre-defined temperature range associated with the chamber temperature setting.

5. The dryer as claimed in claim 4 further including:
at least one second detector sensing the surface temperature of the textile either inside the chamber or as it exits the chamber, the controller receiving the sensed temperature and displaying and/or printing the sensed temperature over time.

6. The dryer as claimed in claim 5 further including an alarm system associated with the controller to make a visual and/or audible alarm alerting an operator when the sensed temperature by the at least one second detector is outside a pre-defined temperature range for a pre-defined length of time.

7. The dryer as claimed in claim 6 wherein the alarm system associated with the controller has two pre-defined lengths of time, such that a first visual and/or audible alarm made when the sensed temperature is outside a pre-defined temperature range for a first pre-defined length of time and a second visual and/or audible arm is made when the sensed temperature is outside a pre-defined temperature range for a second pre-defined length of time.

8. The dryer as claimed in claim 7 wherein the time between the sensing of temperature by the detector can be pre-set.

9. The dryer as claimed in claim 5 further including:
at least one third detector traveling on the mechanism for moving the textiles and sensing the temperature as it travels, the controller receiving the sensed temperature and displaying and/or printing the sensed temperature over time.

10. The dryer for textiles having a heating chamber with an input opening and an exit opening and a mechanism for moving the textiles though the input opening and heating chamber and out the exit opening, comprising:
at least one detector sensing the surface temperature of the textile either inside the chamber or as it exits the chamber;
a controller receiving the sensed temperature and displaying and/or printing the sensed temperature over time.

11. The dryer as claimed in claim 10 further including an alarm system associated with the controller to make a visual and/or audible alarm alerting an operator when the sensed temperature is outside a pre-defined temperature range for a pre-defined length of time.

12. A dryer as claimed in claim 10 wherein the controller stores at least one set of dryer settings associated with the dryer for recalling and applying to the dryer,
each set of dryer settings including:
a chamber temperature setting; and,
a speed setting for the mechanism moving the textiles.

13. The dryer as claimed in claim 10 wherein the alarm system associated with the controller has two pre-defined lengths of time, such that a first visual and/or audible alarm made when the sensed temperature is outside a pre-defined temperature range for a first pre-defined length of time and a second visual and/or audible arm is made when the sensed temperature is outside a pre-defined temperature range for a second pre-defined length of time.

14. The dryer as claimed in claim 13 wherein the time between the sensing of temperature by the detector can be pre-set.

15. A dryer for textiles having a heating chamber with an input opening and an exit opening and a mechanism for moving the textiles through the input opening and heating chamber and out the exit opening, comprising:
at least one detector traveling on the mechanism for moving the textiles and sensing the temperature as it travels; and,
a controller receiving the sensed temperature and displaying and/or printing the sensed temperature over time.

16. The dryer as claimed in claim 15 further including an electrical cord connected to the detector and the dryer has a socket so that the electrical cord can be connected to the socket.

17. A dryer for textiles having a heating chamber with an input opening and an exit opening and a mechanism for moving the textiles through the input opening and heating chamber and out the exit opening, comprising:
a controller for storing at least one set of dryer settings associated with the dryer for recalling and applying to the dryer,
each set of dryer settings including:
a chamber temperature setting; and,
a speed setting for the mechanism moving the textiles.

18. The dryer as claimed in claim 17 wherein the dryer settings further include:
an outfeed temperature setting;
an outfeed temperature off-set to define a pre-defined temperature range; and,
at least one outfeed dwell time associated with an alarm system in communication with the controller for visually and/or audibly alerting an operator when the sensed temperature is outside the pre-defined temperature range for a pre-set period of time.
